(19) United States
(12) Patent Application Publication
(10) Pub. No.: US 2009/0253303 A1
(43) Pub. Date: Oct. 8, 2009

(54) Screw-in adapter for incandescent single-based standard light-bulb

(76) Inventor: Kathryn Chase, Moscow, ID (US)

Correspondence Address: Kathryn Chase, 888 Panorama Dr., Moscow, ID, 83843, US

(21) Appl. No.: 11/951,981

(22) Filed: Apr. 4, 2008

(51) Int. Cl. H01R 31/06

(52) U.S. Cl. 439/628

(57) ABSTRACT

Screw-in adapter for incandescent single-based standard light-bulb size sockets especially made to receive a smaller or larger light bulb. To permit the use of smaller size light bulbs in larger light bulb sockets, i.e. an E26 bulb in a E39 socket or a E12 bulb in a E26 socket, or to permit the use of a larger size light bulb in a smaller light bulb socket, i.e. an E39 bulb in an E26 socket or an E26 bulb in a E12 socket. Also the adapters can be wired to accommodate bulbs of different voltage requirements.

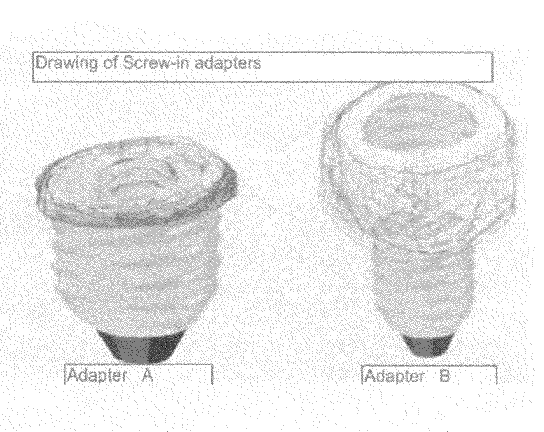

Adapter Sizes

| Adapter | Socket Size | Light-bulb Base Size |
|---|---|---|
| A39/26 | E39 | E26 |
| A26/12 | E26 | E12 |
| B12/26 | E12 | E26 |
| B26/39 | E26 | E39 |

Adapter “A” image depicts an adapter that is configured to accept a smaller sized light-bulb base so that it can be used in a bigger socket.

Adapter “B” image depicts an adapter that is configured to accept a larger sized light-bulb base so that it can be used in a smaller socket.

Please refer to the Adapter Size Table in the abstract for the range of adapters and what size light bulbs and sockets can be interchanged.

I claim:

1. This invention, a Screw-in adapter for incandescent single-based standard light-bulb sized sockets, allows for different sized Edison-based light bulbs to be used in a smaller or larger standard Edison-sized light bulb socket. Additionally, the adapters will be engineered and made to also convert voltage requirements from 240 Volts to 110 Volts or from 110 Volts to 240 Volts or any other voltage conversions needed in the market place.
